(19) United States
(12) Patent Application Publication
(10) Pub. No.: US 2007/0225036 A1
(43) Pub. Date: Sep. 27, 2007

(54) Operation mode switching system and operation mode switch suggestion system

(76) Inventor: Ti-Jang Yang, Sinjhuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/715,940

(22) Filed: Mar. 9, 2007

(30) Foreign Application Priority Data
Mar. 21, 2006 (TW) 095109543

(51) Int. Cl. H04M 1/00

(52) U.S. Cl. 455/553.1

(57) ABSTRACT

An operation mode switching system and an operation mode switch suggestion system are disclosed. The operation mode switch system includes a first portable communication device and at least a second portable communication device. The first portable communication device is for generating a packet to instruct the mode switching. The packet is broadcasted through the path under a short distance wireless communication protocol. The second portable communication device is for receiving the packet. Therefore, a first operation mode is switched to a second operation mode based on the packet.

### FIELD OF THE INVENTION

The present invention relates to an operation mode switching system and an operation mode switch suggestion system, and more particularly to a system that transmits a packet through a short-distance wireless communication protocol to change an operation mode of a communication device or remind users about the change of the operation mode of the communication device.

### BACKGROUND OF THE INVENTION

Almost all mobile phones come with a silent mode or a vibration mode, so that users can continue receiving signals without turning off the mobile phone in special occasions such as attending a meeting or watching a movie in a cinema. If there is an incoming call, the phone will not ring or disturb others in these occasions. However, users have to manually switch their mobile phone to a silent mode or vibration mode, and users usually forget to switch the silent mode or vibration mode of the mobile phone in such occasions, and thus disturbing others and embarrassing the user.

To overcome the foregoing issue of forgetting to switch the operation mode of a mobile phone, the inventor of the present invention based on years of experience to conduct extensive researches and experiments, and finally invented an operation mode switching system and an operation mode switch suggestion system in hope of overcoming the foregoing problem.

### SUMMARY OF THE INVENTION

In view of the foregoing issues, an objective of the present invention is to provide an operation mode switching system and an operation mode switch suggestion system, and particularly a system that transmits a packet through the path under a short-distance wireless communication protocol to change an operation mode of a communication device or suggest users about the change of the operation mode of the communication device.

To achieve the foregoing objective, the operation mode switching system of the invention comprises a first portable communication device and at least one second portable communication device. The first portable communication device is for generating a packet to instruct the mode switching. The packet is broadcasted through the path under a short distance wireless communication protocol. The second portable communication device is for receiving the packet. Therefore, a first operation mode is switched to a second operation mode based on the packet.

The operation mode switch reminder system of the invention comprises a first portable communication device and at least one second portable communication device. The first portable communication device is for generating a suggestion packet. The suggestion packet is broadcasted through the path under a short-distance wireless communication protocol. The second portable communication device is for receiving the suggestion packet and generating a mode switch message based on the suggestion packet.

Since an operation mode switching system and an operation switch mode suggestion system of the invention is under a Bluetooth communication protocol or any other short-distance wireless communication protocol to transmit a packet to a mobile phone or a wireless communication device for appropriately switching an operation mode of the mobile phone or sending a message to suggest a mobile phone user to turn off the ringing function, so as to prevent a telephone from ringing and disturbing of the attendants in a meeting.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a block diagram of an operation mode switching system of the present invention;

FIG. 2 is a block diagram of an operation mode switching system according to a preferred embodiment of the present invention;

FIG. 3 is a block diagram of a first portable communication device of an operation mode switching system of the present invention;

FIG. 4 is a block diagram of a second portable communication device of an operation mode switching system of the present invention;

FIG. 5 is a block diagram of an operation mode switch suggestion system of the present invention;

FIG. 6 is a block diagram of an operation mode switching system according to a preferred embodiment of the present invention;

FIG. 7 is a block diagram of a first portable communication device of an operation mode switch suggestion system of the present invention; and

FIG. 8 is a block diagram of a second portable communication device of an operation mode switch suggestion system of the present invention.

### DETAILED DESCRIPTION OF THE PREFERRED EMBODIMENTS

Refer to the related figures for the operation mode switching system and an operation switch mode suggestion system according to a preferred embodiment of the present invention, wherein the same elements are described by the same reference numerals.

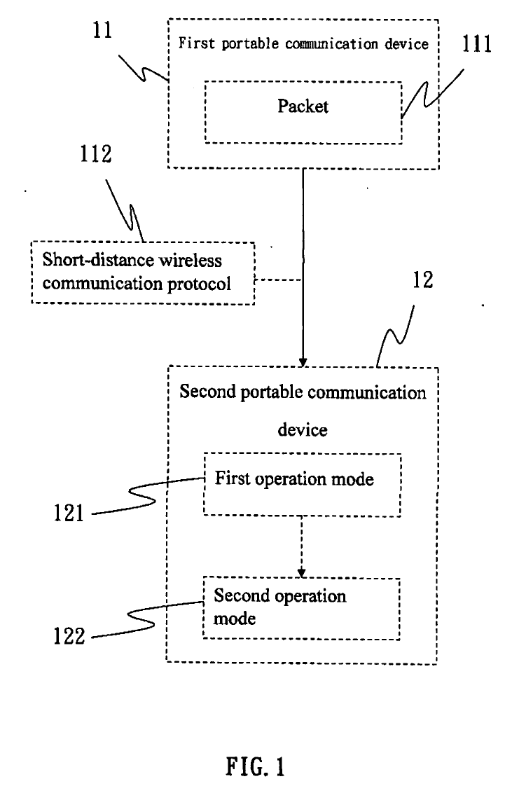

Referring to FIG. 1 for the block diagram of an operation mode switching system of the present invention, the operation mode switching system comprises a first portable communication device 11 and at least one second portable communication device 12. The first portable communication device 11 is provided for generating a packet 111 to instruct the mode switching and broadcasting the packet 111 through the path under a short-distance wireless communication protocol 112. The second portable communication device 12 is provided for receiving the packet 111 and switching the second portable communication device 12 from a first operation mode 121 to a second operation mode 122 based on the packet 111.

The packet 111 further includes a switching time. When the second portable communication device 12 is switched from the first operation mode 121 to the second operation mode 122, time is counted. If the switching time is up, the second portable communication device 12 will be switched from the second operation mode 122 back to the first operation mode 121.

The packet 111 further includes a starting time and an ending time, and the second portable communication device 12 at the starting time switches the first operation mode 121 to the second operation mode 122, and the second portable communication device 12 at the ending time switches the second operation mode 122 back to the first operation mode 121.

The first portable communication device 11 and the second portable communication device 12 are preferably mobile phones, and the short-distance wireless communication protocol 112 is preferably a Bluetooth communication protocol, and the first operation mode 121 is preferably a ringing mode, and the second operation mode 122 is preferably a vibration mode, a silent mode or a shutdown mode.

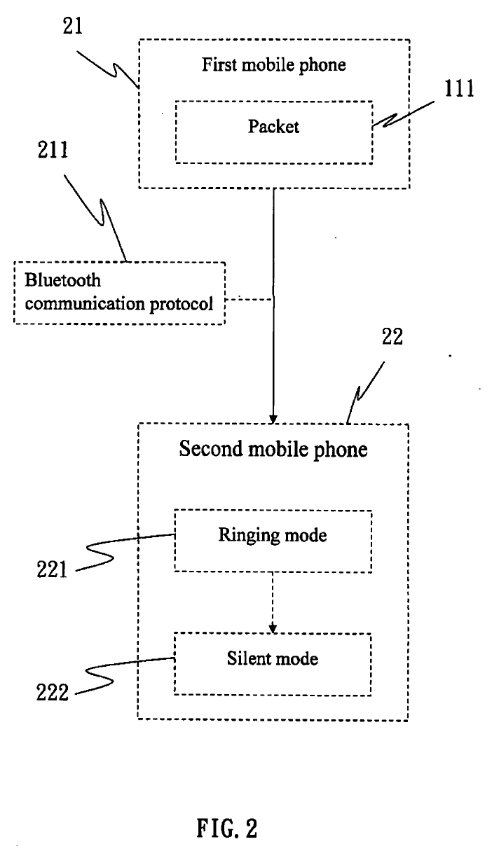

Referring to FIG. 2 for the block diagram of an operation mode switching system of the present invention, the operation mode switching system comprises a first mobile phone 21 and at least one second mobile phone 22. The first mobile phone 21 is provided for generating a packet 111 to instruct the mode switching and broadcasting the packet 111 through the path under a Bluetooth communication protocol 211. The second mobile phone 22 is provided for receiving the packet 111 and switching the operation mode of the second mobile phone 22 from a ringing mode 221 to a silent mode 222 based on the packet 111.

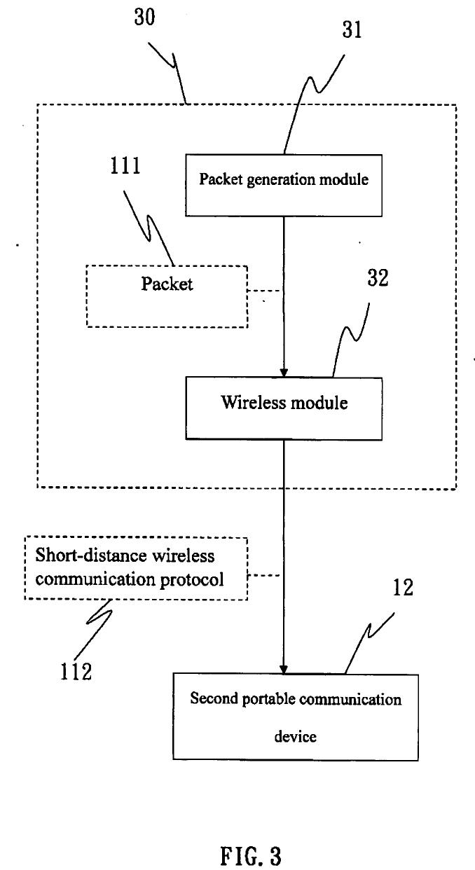

Referring to FIG. 3 for the block diagram of a first portable communication device of an operation mode switching system of the present invention, the communication device 30 comprises a packet generation module 31 and a wireless module 32. The packet generation module 31 is provided for generating a packet 111 to instruct the mode switching, and the wireless module 32 is provided for broadcasting the packet 111 through the path under a short-distance wireless communication protocol 112, and the second portable communication device 12 receives the packet 111.

The communication device 30 is preferably a mobile phone, and the short-distance wireless communication protocol 112 is preferably a Bluetooth communication protocol.

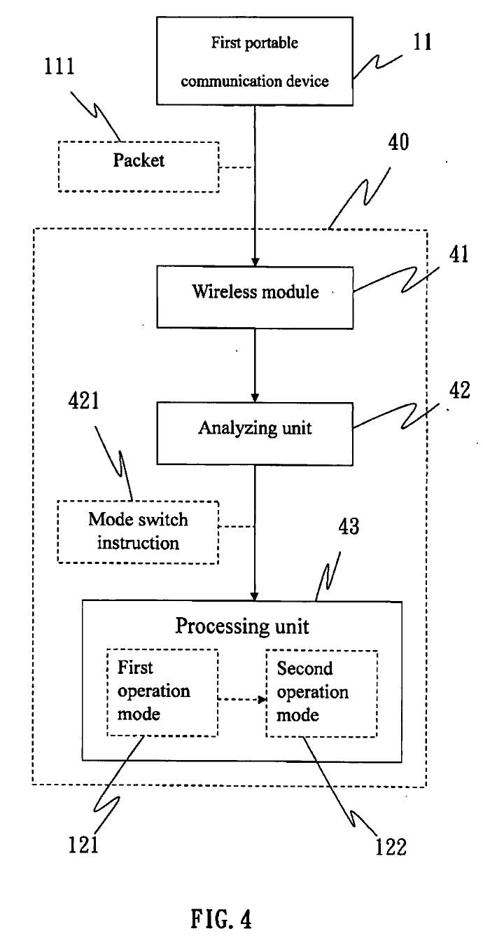

Referring to FIG. 4 for the block diagram of a second portable communication device of an operation mode switching system of the present invention, the communication device 40 comprises a wireless module 41, an analyzing unit 42 and a processing unit 43. The wireless module 41 is provided for receiving the packet 111 to instruct the mode switching, and the analyzing unit 42 is provided for analyzing the packet 111 and sending out a mode switch instruction 421 based on the packet 111, and the processing unit 43 is provided for switching the communication device 40 from a first operation mode 121 to a second operation mode 122 based on the mode switch instruction 421.

The packet 111 further includes a switching time. When the communication device 40 switches the first operation mode 121 to the second operation mode 122, time is counted by the processing unit. If the switching time is up, the communication device 40 will be switched from the second operation mode 122 back to the first operation mode 121.

The packet 111 further includes a starting time and an ending time, and the communication device 40 at the starting time is switched from the first operation mode 121 to the second operation mode 122, and the communication device 40 at the ending time is switched from the second operation mode 122 back to the first operation mode 121.

The communication device 40 is preferably a mobile phone, and the first operation mode 121 is preferably a ringing mode, and the second operation mode 122 is preferably a vibration mode, a silent mode or a shutdown mode.

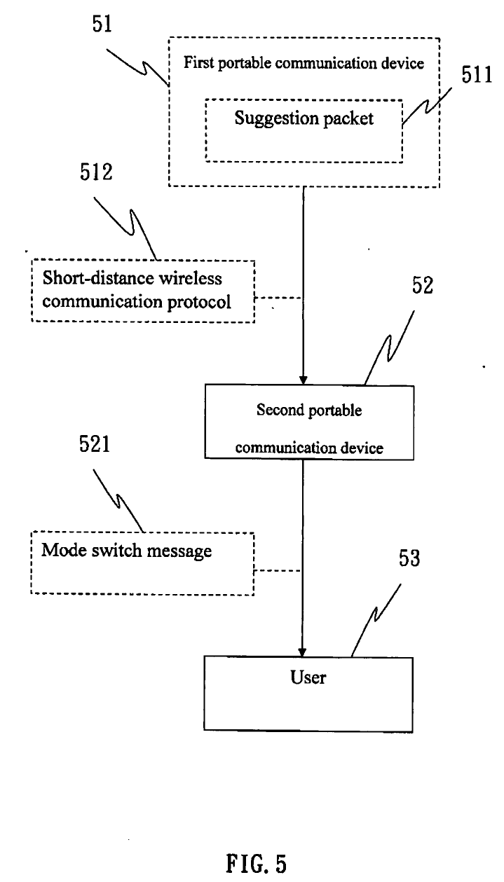

Referring to FIG. 5 for the block diagram of an operation mode switch suggestion system of the present invention, the operation mode switch suggestion system comprises a first portable communication device 51 and at least one second portable communication device 52. The first portable communication device 51 is provided for generating a suggestion packet 511 to instruct the mode switching and broadcasting the suggestion packet 511 through the path under a short-distance wireless communication protocol 512. The second portable communication device 52 is provided for receiving the suggestion packet 511 and generating a mode switch message 521 based on the suggestion packet 511 to suggest a user 53 of the second portable communication device to switch the operation mode.

The suggestion packet 511 further includes a switching time. When the second portable communication device 52 generates a mode switch message 521, time can be counted by a processing unit of the second portable communication device 52. If the switching time is up, a recovery message will be generated. The suggestion packet 511 further includes a starting time and an ending time. The second portable communication device 52 at the starting time generates a mode switch message 521, and the second portable communication device 52 at the ending time generates a recovery message. The first portable communication device 51 and the second portable communication device 52 are preferably mobile phones, and the short-distance wireless communication protocol 512 is preferably a Bluetooth communication protocol.

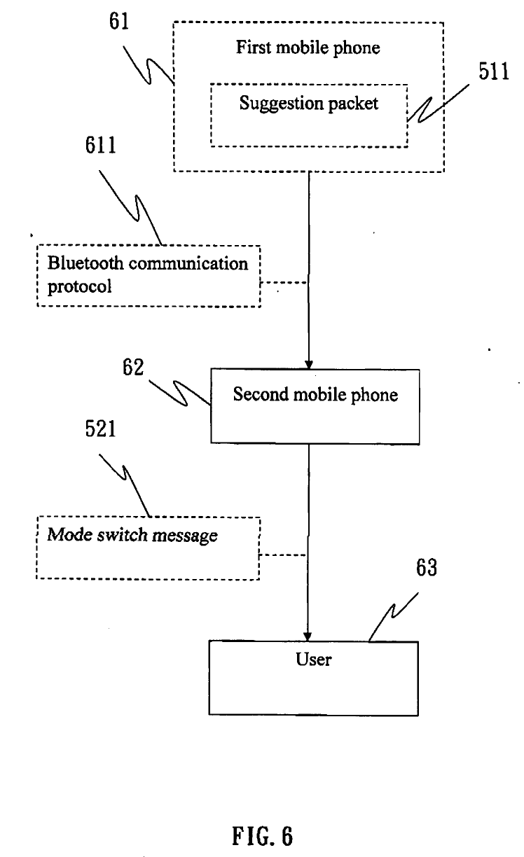

Referring to FIG. 6 for the block diagram of an operation mode switching system according to a preferred embodiment of the present invention, the operation mode switching system comprises a first mobile phone 61 and at least one second mobile phone 62. The first mobile phone 61 is provided for generating a suggestion packet 511 to instruct the mode switching and broadcasting the suggestion packet 511 through the path under the Bluetooth communication protocol 611. The second mobile phone 62 is provided for receiving the suggestion packet 511 and generating a mode switch message 521 based on the suggestion packet 511 to suggest a user 63 of the second mobile phone to switch the operation mode.

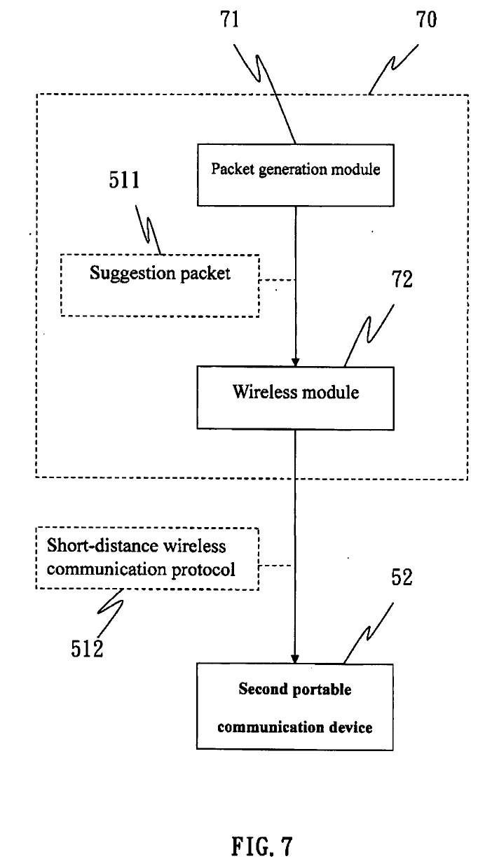

Referring to FIG. 7 for the block diagram of a first portable communication device of an operation mode switch suggestion system of the present invention, the communication device 70 comprises a packet generation module 71 and a wireless module 72. The packet generation module 71 generates a suggestion packet 511, and the wireless module 72 broadcasts the suggestion packet 511 through the path under a short-distance wireless communication protocol 512, and the second portable communication device 52 receives the suggestion packet 511.

The communication device 70 is preferably a mobile phone, and the short-distance wireless communication protocol 512 is preferably a Bluetooth communication protocol.

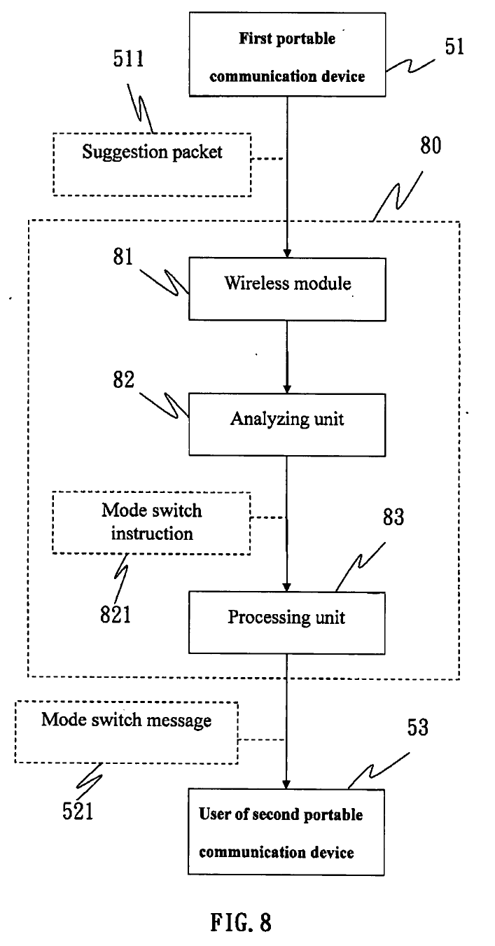

Referring to FIG. 8 for the block diagram of a second portable communication device of an operation mode switch suggestion system of the present invention, the communication device 80 comprises a wireless module 81, an analyzing unit 82 and a processing unit 83. The wireless module 81 is provided for receiving the suggestion packet 511, and the analyzing unit 82 is provided for analyzing the suggestion packet 511 and sending out a mode switch instruction 821 based on the suggestion packet 511, and the processing unit 83 is provided for generating a mode switch message 521 based on the mode switch instruction 821 to suggest a user 53 of the second portable communication device to switch the operation mode.

The suggestion packet 511 further includes a switching time. When the processing unit 83 generates the mode switch message 521, time is counted. If the switching time is up, the processing unit 83 will generate a recovery message. The suggestion packet 511 further includes a starting time and an ending time, and the processing unit 83 at the starting time generates a mode switch message 521, and the processing unit 83 at the ending time generates a recovery message, and the communication device 80 is preferably a mobile phone.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An operation mode switching system, comprising:
a first portable communication device for generating a packet to instruct mode switching, and broadcasting said packet through the path under a short-distance wireless communication protocol; and
at least one second portable communication device for receiving said packet, and switching said at least one second portable communication device from a first operation mode to a second operation mode based on said packet.

2. The operation mode switching system of claim 1, wherein said packet further comprises a switching time, and when said at least one second portable communication device is switched from said first operation mode to said second operation mode, time is counted by a processing unit of said at least one second communication device, and when said switching time is up, said at least one second portable communication device is switched from said second operation mode back to said first operation mode.

3. The operation mode switching system of claim 1, wherein said packet further includes a starting time and an ending time, and said at least one second portable communication device at said starting time switches said first operation mode to said second operation mode, and said at least one second portable communication device at said ending time switches said second operation mode back to said first operation mode.

4. The operation mode switching system of claim 1, wherein said first communication device and said at least one second communication device are mobile phones.

5. The operation mode switching system of claim 1, wherein said first operation mode is a ringing mode.

6. The operation mode switching system of claim 1, wherein said second operation mode is a vibration mode, a silent mode or a shutdown mode.

7. A communication device, applicable to an operation mode switching system, and said communication device comprising:
a packet generation module for generating a packet to instruct mode switching; and
a wireless module for broadcasting said packet through the path under a short-distance wireless communication protocol.

8. A communication device, applicable to an operation mode switching system, and said communication device comprising:
a wireless module for receiving a packet to execute mode switching;
an analyzing unit for analyzing said packet and sending out a mode switch instruction based on said packet; and
a processing unit for switching said communication device from a first operation mode to a second operation mode based on said mode switch instruction.

9. The communication device of claim 8, wherein said packet further includes a switching time, and when said communication device switches said first operation mode to said second operation mode, said processing unit starts to count time, and when said switching time is up, said processing unit switches said communication device from said second operation mode back to said first operation mode.

10. The communication device of claim 8, wherein said packet further includes a starting time and an ending time, and said processing unit at said starting time switches said communication device from said first operation mode to said second operation mode, and said processing unit at said ending time switches said communication device from said second operation mode back to said first operation mode.

11. The communication device of claim 8, wherein said first operation mode is a ringing mode.

12. The communication device of claim 8, wherein said second operation mode is a vibration mode, a silent mode or a shutdown mode.

13. An operation mode switch suggestion system, comprising:
a first portable communication device for generating a suggestion packet to instruct mode switching and broadcasting said suggestion packet through the path under a short-distance wireless communication protocol; and
at least one second portable communication device for receiving said suggestion packet and generating a mode switch message based on said suggestion packet.

14. The operation mode switch suggestion system of claim 13, wherein said suggestion packet further includes a switching time, and when said at least one second portable communication device generates said mode switch message, time is counted by a processing unit of said at least one second portable communication device, and when said switching time is up, said at least one second portable communication device generates a recovery message.

15. The operation mode switch suggestion system of claim 13, wherein said suggestion packet further includes a starting time and an ending time, and said at least one second portable communication device at said starting time generates said mode switch message, and said at least one second portable communication device at said ending time generates a recovery message.

16. The operation mode switch suggestion system of claim 13, wherein said first portable communication device and said at least one second portable communication device are mobile phones.

17. A communication device, applicable to an operation mode switch suggestion system, and said communication device comprising:
a packet generation module for generating a suggestion packet to instruct mode switching; and
a wireless module for broadcasting said suggestion packet through the path under a short-distance wireless communication protocol.

18. A communication device, applicable to an operation mode switch suggestion system, and said communication device comprising:
a wireless module for receiving a suggestion packet;
an analyzing unit for analyzing said suggestion packet and sending out a mode switch instruction based on said suggestion packet; and
a processing unit for generating a mode switch message based on said mode switch instruction.

19. The communication device of claim 18, wherein said suggestion packet further includes a switching time, and when said processing unit generates said mode switch message, time is counted, and when said switching time is up, said processing unit generates a recovery message.

20. The communication device of claim 18, wherein said suggestion packet further includes a starting time and an ending time, and said processing unit at said starting time generates said mode switch message, and said processing unit at said ending time generates a recovery message.
